(19) United States
(12) Patent Application Publication
(10) Pub. No.: US 2021/0153691 A1
(43) Pub. Date: May 27, 2021

(54) Herb Storage Container With Resin Gland Particle Collection Compartment

(71) Applicants: Travis Lemasters, Austin, TX (US); Steve Kelnhofer, Austin, TX (US)

(72) Inventors: Travis Lemasters, Austin, TX (US); Steve Kelnhofer, Austin, TX (US)

(21) Appl. No.: 17/060,045

(22) Filed: Sep. 30, 2020

Related U.S. Application Data
(60) Provisional application No. 62/908,589, filed on Sep. 30, 2019.

(51) Int. Cl. A47J 42/30

(52) U.S. Cl. CPC A47J 42/30

(57) ABSTRACT

The present invention relates to a device and a method associated with the device. With respect to the device, it is an herb storage container, which is an airtight herb storage container that has a method of collecting fine resin gland particles in a connected compartment. This device can be used to store herbs in order to keep them fresh, it allows the user to collect strain specific fine resin gland particles in a connected compartment and accomplishes this through the floor of the main chamber being made of a mesh screen. The core components of the invention are a lid, a silicone humidity pack holder that is fitted up in the inner part of the lid also functions as an airtight seal mechanism, a second modified lid with the center portion removed and threads on the lining of the removed center portion that allows the attachment of a handheld herb grinder, a dually open ended plastic, glass or aluminum jar with threads on both ends, an adapter that holds a removable screen, a removable screen, a part that unscrews from the adapter to allow removal and replacement of the mesh screen, a section that has a closed floor that collects the fine resin gland particles and a second smaller glass, plastic or aluminum jar that stores ground herbs, which, generally speaking, are configured as follows: lid, silicone humidity pack holder, glass, plastic or aluminum jar, jar adapter, mesh screen, mesh screen holder, fine resin gland particle storage compartment and lastly at the very bottom is the glass, plastic or aluminum ground herb storage jar. With respect to the device it should be further noted that because of a unique feature of having the second modified lid the user can now screw a handheld grinder with matching threads into the lid of the jar and grind directly into the storage container which can then be agitated to sift the fine resin gland particles into the compartment below. With respect to the associated method, in order to carry out the method the following core steps are followed: step one is to remove the lid by unscrewing it from the jar and replacing it with the second modified lid, step two is to attach the handheld grinder to the lid by screwing it into the threads on the open missing center portion of the modified lid, step three is to use the hand held grinder to grind the herb from a nug form into a ground form, step four is to remove the grinder from the top of the modified lid by unscrewing it and then removing the modified lid from the jar and replacing it with the first lid, the fifth step is to then agitate the storage container so that the fine resin gland particles can be sifted into the next compartment of the container, the sixth step is to remove the lid and to remove the ground herb storage jar from the very bottom of the container and then dump the ground herb into the ground herb storage jar and then screw the ground herb storage jar back onto the bottom side of the fine resin gland particle storage compartment and screw the lid back onto the top of the storage container. Also, with respect to the device it should be further noted that because of a unique feature of having a jar that has a mesh screen bottom with another compartment underneath, the user can take unground herbs and store them in the storage container and agitate the entire container so that the fine resin gland particles can detach and fall through the mesh screen into the next compartment below. With respect to the associated method, in order to carry out the method the following core steps are followed: step one is to remove the lid, step two is to place the unground herbs into the jar, step three is to place the lid back on the jar by screwing it back onto the jar, step four is to agitate the storage container so that the fine resin gland particles can sift through the mesh screen into the compartment down below. Ultimately, at the conclusion of the two series of steps described above, one has now stored their herbs in a airtight environment, they have a method of grinding herbs directly into the jar so that they can collect strain specific fine resin gland particles and keep them both organized and categorized and one can take their airtight stored unground herbs and collect the fine resin gland particles in the compartment below the mesh screen.

### BACKGROUND

### 1. Field of the Invention

The invention relates generally to an herb storage container with a resin gland particle collection compartment.

### 2. Background

Currently there are a few solutions for storing herbs but none of them have features that address the needs of the industry. These other solutions in the industry only address the need for storing herbs but do not address the need for achieving any other goals other than simply storing dry herbs. These solutions fail to meet the needs of the industry because there are a few additional needs within the storing process that can be met with our design. These needs include the desire to collect strain specific fine resin gland particles through the storage process by having a storage jar with a mesh screen bottom and another compartment below for catching and storing these particles; and having a single jar where you can store unground herbs, fine resin particles and ground herbs. Additionally, there is a desire and a need for a storage jar that unground herbs can be directly ground into so that strain specific fine resin gland particles can be collected and stored and our design addresses this as well.

### SUMMARY OF THE INVENTION

It is desirable to have a device that can store unground herbs that can also be agitated in order to collect the fine resin gland particles. Furthermore, it would also be desirable to have a device that stores ground herbs in a separate compartment than the unground herbs. Still further, it would be desirable to have a device that stores unground and ground herbs, in an airtight environment, in separate compartments and be able to attach a handheld manual grinder to the storage container in order to grind directly into it so that the user can collect strain specific fine resin gland particles. The disclosed device and associated method advantageously fill these needs and addresses the aforementioned deficiencies by providing one product that can store ground herbs, unground herbs and fine herb resin gland particles in an airtight environment and be able to collect strain specific resin gland particles through agitation and also be able to remove the lid and replace it with a modified lid in order to attach a manual handheld grinder so that the user can grind directly into the storage container and then agitate in order to collect the strain specific fine resin gland particles.

Disclosed is an Herb Storage Container With Resin Gland Particle Collection Compartment , which is made up of the following components; a lid, a silicone humidity pack holder that functions as an airtight mechanism as well, a second modified lid that has a missing center portion and threads on the outer lining of the missing portion, a double open ended jar with threads on both ends, an adapter that holds a mesh screen, a part that is removable that holds the mesh screen tightly in place, a compartment for storing fine resin gland particles and a small glass jar for storing ground herbs. These components are connected in the following way; the lid is at the very top and screws onto the top of the double open ended jar, a silicone humidity pack holder that is fitted up into the inner part of the lid and functions as an airtight mechanism as well, also a second modified lid with a missing center portion, the double open ended jar then screws into the adapter that holds the mesh screen, below that mesh screen are threads on the adapter that allow the screen holder part to be screwed flush up to the screen, below that is the compartment that holds the resin gland particles and that compartment has a lip underneath it with more threads and the small jar for holding ground herbs screws into those threads and is the very bottom part of the product.

The device may also have one or more of the following: an additional feature is that the adapter part that houses the mesh screen and the other components that are below it can remain connected to the adapter part and that can then be screwed onto an electric herb grinder with that has a grinding compartment with the same threads as the adapter threads. This characteristic will allow the user to collect strain specific resin glad particles as well. Similarly, the associated method may also include one or more of the following steps: step one is to collectively remove the bottom half of the storage container by unscrewing the adapter part that houses the mesh screen and keeping it connected to the rest of the parts that are below it, step two is to screw that adapter part that houses the mesh screen onto an electric grinder that has the same threads and then use the grinder and collect the desired strain of resin gland particles in the compartment under the mesh screen, step three is to then unscrew the adapter from the electric grinder with matching threads and reattach it to the storage container.

The disclosed device is unique when compared with other known devices and solutions because it provides: (1) it has a mesh screen bottom floor instead of a solid bottom floor (2) a design that enables consumers to store their dry herbs, their ground dry herbs and their strain specific fine resin gland particles in separate compartments within one jar; (3) enables the consumer to attach a handheld manual grinder to the lid and grind directly into the inside of the jar; (4) allows consumers to firmly hold a humidity pack within the lid of the jar so that it doesn't touch the herbs; and (5) has a bottom portion that detaches and can attach to an electric herb grinder with the same thread pattern and collect strain specific fine resin gland particles through that method. This is a unique design that does not exist in the current marketplace and solves many of the consumers' needs within the market.

The disclosed device is unique in that it is structurally different from other known devices or solutions. More specifically, the device is unique due to the presence of: (1) a second adapter lid that allows a handheld grinder to be attached; (2) a silicone humidity pack holder that has two functions; one to hold the humidity pack away from the herbs and two to act as the air tight seal in the lid; (3) a mesh screen bottom that allows the passage of only the fine resin gland particles into the next compartment; and (4) three separate compartments for storing unground herbs, ground herbs and fine resin gland particles.

Furthermore, the process associated with the aforementioned device is likewise unique. More specifically, the disclosed process owes its uniqueness to the fact that it: (1) can work interchangeably with an electric herb grinder in order to collect strain specific fine resin gland particles through the grinding process; (2) it can be agitated while the herbs are being stored and that process collects the fine resin particles that fall off during the agitation; (3) through the second modified adapter lid can work with a handheld manual grinder so that herbs can be ground straight into the jar and land on the mesh screen enabling the passage of fine resin gland particles to be collected in the compartment below.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The Herb Storage Container With Resin Gland Particle Collection Compartment may, however, be embodied in many different forms and should not be construed as being limited to the embodiments set forth herein; rather, these embodiments are provided by way of illustration only and so that this disclosure will be thorough, complete and fully convey understanding to those skilled in the art.

### BRIEF DESCRIPTION OF THE DRAWINGS

FIG. 1.—Shows a segmented view of the jar from top to bottom, with the very top part being the alternative second modified lid.

### DETAILED DESCRIPTION

The present invention is directed to an herb storage container with resin gland particle collection compartment.

In its most complete form, the device is made up of the following components; a lid with threads, a silicone humidity pack holder that is also what makes the lid airtight, a second modified lid with a missing center portion with threads on the outer lining of the center missing portion, a double open ended glass, plastic or aluminum jar, an adapter that has threads on one side so that it can screw onto the bottom of the jar, a mesh screen, a part that holds the mesh screen in place and allows it to be removed and replaced, a compartment that stores fine resin gland particles and a small jar with threads only on the top end. These components are connected in the following way; the lid is at the very top and screws onto the top of the double open ended jar, the silicone humidity pack holder is permanently fitted up into the inner part of the lid, a second modified lid can replace the original lid for the grinding process, the double open ended jar then screws into the adapter that holds the mesh screen, below that mesh screen are threads on the adapter that allow the screen holder part to be screwed flush up to the screen, below that is the compartment that holds the resin gland particles and that compartment has a lip underneath it with more threads and the small jar for holding ground herbs screws into those threads and is the very bottom part of the product. It should further be noted that: all the components from the adapter down can, be removed as one unit and screwed onto the top of an electric grinder that has the same threading.

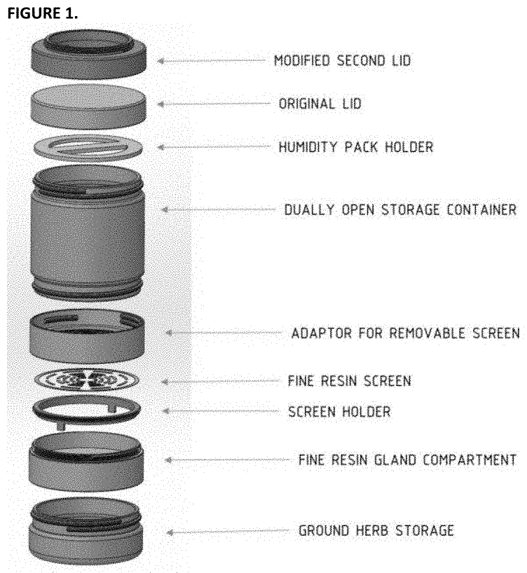

The most complete form of performing the method associated with the disclosed device consists of the following steps; step one is to remove the original lid and replace it with the second modified lid, step two is to attach the handheld grinder to the lid by screwing it in, step three is to use the handheld grinder to grind the herb from a nugget form into a ground form, step four is to remove the grinder from the top of the modified lid by unscrewing it and then replacing the modified lid with the original lid, the fifth step is to then agitate the storage container so that the fine resin gland particles can be sifted into the next compartment of the container, the sixth step is to remove the lid and to remove the ground herb storage jar from the very bottom of the container and then dump the ground herb into the ground herb storage jar and then screw the ground herb storage jar back onto the underside of the fine resin gland particle compartment and screw the lid back onto the top of the storage container. Also, with respect to the device it should be further noted that because of a unique feature of having a jar that has a mesh screen bottom with another compartment underneath, the user can take unground herbs and store them in the storage container and agitate the entire container so that the fine resin gland particles can detach and fall through the mesh screen into the next compartment below. With respect to the associated method, in order to carry out the method the following core steps are followed: step one is to remove the lid, step two is to place the unground herbs into the jar, step three is to place the lid back on the jar by screwing it back onto the jar, step four is to agitate the storage container so that the fine resin gland particles can sift through the mesh screen into the compartment down below. Ultimately, at the conclusion of the two series of steps described above, one has now stored their herbs in an airtight environment, they have a method of grinding herbs directly into the jar so that they can collect strain specific fine resin gland particles and keep them both organized and categorized and one can take their airtight stored unground herbs and collect the fine resin gland particles in the compartment below the mesh screen. FIG. 1 shows the segmented front view of the invention from top to bottom. At the very top is the modified alternative second lid which allows a handheld manual grinder to be attached so that the consumer can grind the herbs directly into the jar. Next is the original lid with the silicone humidity pack hold directly below it, which is permanently fitted up into the inner part of the lid. Below that is the main unground herb storage compartment known as the dually open storage container and below that is the adapter that houses the mesh screen. That mesh screen is secured tightly in place by the next part which is the screen holder and below that part is the fine resin gland compartment that collects the fine particles that fall through the mesh screen. And lastly at the very bottom is the ground herb storage container that houses the consumers ground herbs.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

1. An airtight storage jar for herbs that has an adapter that houses a removable mesh screen that acts as the bottom of the jar and enables the user to collect resin gland particles into a second compartment that is connected to the underside of the adapter.

2. An airtight storage jar for herbs that has a lid with a circular silicone insert that acts as the airtight mechanism for the top portion of the jar and also functions as a humidity pack holder.

3. An airtight storage jar for herbs that has an adapter lid that is cored out in the center with a lip extending out from the top side that has threads on the outside of the lip enabling the user to screw on and attach the top half of a handheld herb grinder that has matching thread design.
